(19) United States
(12) Patent Application Publication
(10) Pub. No.: US 2005/0159189 A1
(43) Pub. Date: Jul. 21, 2005

(54) Method and apparatus for use in accessing and displaying data on a limited display

(75) Inventor: Hariprasad Janardana Iyer, Plantation, FL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/749,151

(22) Filed: Dec. 30, 2003

(51) Int. Cl. H04M 1/00; H04B 1/38; G06F 9/00; G06F 3/00; G06F 17/00

(52) U.S. Cl. 455/566; 455/575.3; 455/575.1

(57) ABSTRACT

A method, apparatus and system are provided for use in accessing data in handheld devices. One embodiment provides an apparatus for use in wirelessly communicating that comprises first and second parts that are pivotably attached to be opened and closed; an exterior display; a first actuator that causes a shift of the data on the display to show a first alternate portion of the data; a second actuator that shifts data to display a second alternate portion of the data; and a third actuator that shifts the data to display a third alternate portion when activated for a predefined period, and/or to display a fourth portion or fifth portion when the first or second actuators, respectively, are activated while the third actuator is activated. Typically, the first, second and third actuators are accessible when the apparatus is in the closed position.

### FIELD OF THE INVENTION

The present invention relates generally to accessing data on devices capable of storing data, and more particularly to accessing and viewing data on portable, handheld devices.

### BACKGROUND OF THE INVENTION

The number of handheld, portable devices has exploded over the last decade, and the number of users of handheld, portable devices has increased at an even faster rate. These devices can include wireless phones, personal digital assistant devices, global positioning system devices, MPEG-1 Audio Layer-3 (MP3) devices, portable compact disc players and other similar devices.

Each of these devices accesses data and supplies that data to a user. Some even display data to the user on a display or screen. The user utilizes control keys or buttons to access the data desired and the data is displayed on the display. Some devices even include more than one display.

For example, some wireless phones open and close to protect the main interior display as well as the function or actuator buttons. This provides added protection, prevents inadvertent selection of buttons and reduces wear and tear on the main display and buttons. Some of these opening phones additionally include a small or limited display on an exterior of the phone to be viewed by a user when the phone is in the closed position. The user can access some data from the phone to be displayed on the external display.

Because of the small dimensions of the external display, the data that can be displayed is limited. Further, these phones fail to provide a user with adequate capabilities of viewing the data and accessing data associated with the limited data that does get displayed on the small, external display.

### BRIEF DESCRIPTION OF THE DRAWINGS

The above needs are at least partially met through provision of the methods, apparatuses, and systems for use in accessing data on a handheld device to be displayed on an external display described in the following detailed description, particularly when studied in conjunction with the drawings, wherein:

FIG. 1 depicts a simplified, prospective view of a wireless, handheld device that has two parts which are pivotably connected;

FIG. 2 shows the clam device in a closed position, with the exterior or outer shell of the second part shown, including an external display;

FIG. 3 depicts a simplified block diagram of an external display according to some embodiments;

FIG. 4 shows the external display, similar to that of FIG. 3, with a subsequent entry in a list;

FIG. 5 shows the external display, similar to that of FIGS. 3-4, with an entry displayed following the receipt of a command to scroll or shift the data to the right or left;

FIG. 6 shows the display of FIG. 5 after the data has been scrolled, for example, to show data to the right;

FIG. 7 shows data similar to that of FIG. 5 where a name associated with a recent call is displayed;

FIG. 8 shows the display, similar to that of FIG. 7, following a selection of data, for example the name associated with a recent call;

FIG. 9 shows the external display, similar to that of FIG. 8, with the data scrolled to display a mobile phone number associated with the entry;

FIG. 10 shows the external display of FIGS. 8-9 depicting additional data after further scrolling to display an additional contact number;

FIG. 11 shows the display of FIGS. 8-10 depicting a subsequent entry in the address book list;

FIG. 12 depicts a simplified block diagram of a handheld device, according to some embodiments;

FIG. 13 depicts a simplified flow diagram of process for displaying data on an external display; and

FIG. 14 shows a simplified flow diagram of a process for selecting data displayed on the external display.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Present embodiments provide for optimized access of data stored on a handheld device, and for optimized scrolling through data stored on handheld device. The present embodiments are particularly applicable to handheld devices that have two halves or parts, and these two parts are hinged to open and expose the interior or inner surfaces of the two parts. The device can be a cellular phone, a personal digital assistant (PDA), a cordless phone, a multimedia player (e.g., a CD player, MP3 player and the like), devices utilizing Motorola's Integrated Digital Enhanced Network (iDEN™) products and other similar handheld devices.

In some embodiments, a handheld, portable apparatus is provided that includes first and second parts, each having interior and exterior surfaces. The first and second parts are pivotally attached so that they can be opened and closed. In a closed position the interior surfaces of the first and second parts are proximate to and face each other. An exterior display is also included on the exterior to display data so that the apparatus does not have to be opened to access data. First, second, and third actuators are secured to and/or-are accessible from the exterior of the apparatus. The first actuator causes a shift of the data on the exterior display when activated so that a first alternate portion of the data is displayed. The second actuator causes a shift of the data on the exterior display when activated so that a second alternate portion of the data is displayed. The third actuator causes a shift in a default direction of the data on the exterior display when the third actuator is activated and held activated for a predefined period of time so that a third alternate portion of the data is displayed. Further, the first actuator can cause a shift of the data on the exterior display so that a fourth alternate portion of the data is displayed when the first actuator is activated while the third actuator is activated, and similarly, the second actuator can cause a shift of the data on the exterior display so that a fifth alternate portion of the data is displayed when the second actuator is activated while the third actuator is activated. In some implementations, the third alternate portion of data can be the same as one of the fourth or fifth alternate portions of data. In some preferred embodiments, the first, second and third actuators are positioned on the side of the apparatus so that they are accessible when the apparatus is in the closed position.

The first through fifth alternate data can be accessed, in some preferred embodiments, by shifting the data. For example, the first actuator can cause a shift of the data in a first direction, such as to the left, when the first actuator is activated while the third actuator is activated so that a first portion of a first entry of a list is displayed, while the second actuator can cause a shift of the data in a second direction, such as to the right, when the second actuator is activated while the third actuator is activated so that a second portion of the first entry is displayed. Similarly, the first actuator can cause the shift of the data in a third direction, such as up, when the first actuator is activated while the third actuator is not activated so that a first portion of a succeeding second entry of the list is displayed, and the second actuator can cause a shift of the data in a fourth direction, such as down, when the second actuator is activated while the third actuator is not activated so that a first portion of a preceding third entry of the list is displayed. In some embodiments, the third command can scroll the data on the external display in a default direction to display a fifth additional data when the third command is active for a predefined period while the neither the first and second commands are active.

Some embodiments provide a method for use in accessing data on a portable, handheld device. The method can display data on an external display of a handheld device while the handheld device is in a closed position. Additionally, while the handheld device is closed, the method can scroll the data on the external display in a first direction to display first additional data when a first command is received, and scroll the data in a second direction to display second additional data when a second command is received. Still further, the method can scroll the data in a third direction to display third additional data when the first command is received while a third command is active, as well as scroll the data in a fourth direction to display fourth additional data when the second command is received while the third command is active.

Additional embodiments provide a method for use in displaying data on a handheld device. The method can display a first portion of a first entry of data on an external display of the handheld device while the handheld device is in a closed position, and display a first portion of a second entry of data on the external display when a first command is received while a third command is not received. The method can further display a second portion of the first entry of data on the external display when the first command is received while the third command is received, and display a third portion of the first entry of data on the external display when a second command is received while the third command is received.

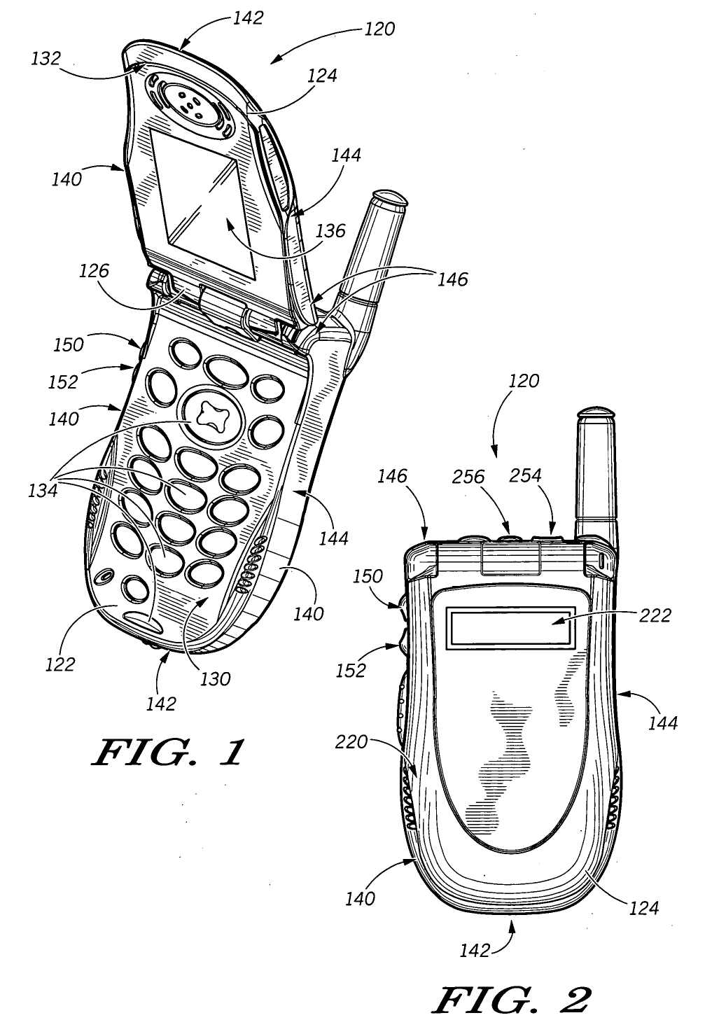

FIG. 1 depicts a simplified, prospective view of a wireless, handheld device 120 that has two parts 122, 124 that are pivotably connected. The two parts can be connected by a hinge 126 or other method to allow the two parts to be opened. FIG. 2 shows the clam device 120 in a closed position, with the exterior or outer shell 220 of the second part shown 124. Referring to FIGS. 1 and 2, when the device 120 is open, the interior faces 130 and 132 are exposed for viewing and access. Typically, the device includes actuation and control buttons or keys 134 and other control features on the interior face 130 of the first part 122, and a main display 136, such as a liquid crystal display (LCD), light emitting diode (LED) display, a touch screen display to allow further control input, or other similar displays. The two parts 122, 124 can have additional buttons/keys 150, 152, 254 (see FIG. 2), control features (e.g., rotating dials) and access ports 256 (e.g., headset port, USB port(s) (and other ports for connecting with external devices, such as computers, keyboards, displays, phone lines and the like), power connection port, card ports/slots or other similar ports) on the sides 140, 142, 144, 146. For example, a volume up button or key 150 and volume down button or key 152 can be included on the side 140. The device 120 can include any number of buttons, control features and/or ports can be positioned on the sides, on the interior surfaces and/or on the exteriors 220 (see FIG. 2), in substantially any configuration.

Because of manufacturing constraints, however, some embodiments are limited to predefined configurations with a specific number and specifically located actuator buttons. In some embodiments, the volume buttons 150, 152 can be positioned on the side 140. In preferred embodiments, these buttons provide additional operations or functions while the volume is not being adjusted, cannot be adjusted because of operating constraints, and/or is controlled through other buttons, menus displayed on the main display 136 (when the device is open), or through a touch screen main display (when the device is open).

The main display 136 can be configured to display substantially any information that can be accessed by the device, whether from locally stored data or remotely accessed data (including wirelessly accessed data, such as data wirelessly retrieved from over the Internet). The main display 136 is only viewable when the device is open.

Through the hinge 126, the two parts 122, 124 can be closed so that the interior faces 130 and 132 are positioned proximate to each other and facing each other. These types of devices that open and close are often referred to as “clam” or “clamshell” devices, because they open and close similar to a clam. When the device 120 is closed, the main display 136 and buttons 134 are protected from damage and wear. Further, by closing the device, the inadvertent pressing of buttons and control features on the interior faces 130, 132 is reduced or prevented. Additionally, of course, when closed the main display cannot be viewed.

Still referring to FIGS. 1 and 2, preferred embodiments of the handheld device 120 have an additional, external display 222 on the outer shell 220. This external display 222 allows a user to access data stored within the handheld device, wired or wirelessly received or accessed through the device, without having to open the clam device 120. In some embodiments, the external display may be implemented through external transparent window allowing a user to view a limited portion of the main display when the device is closed. The external display 222 in many devices is a limited display and does not display as much information as can be viewed from the main display 136. For example, the external display 222 may only provide a single line of text. This single line of text can be a single entry of a string of data, a list and other information.

Many of the present embodiments allow users to scroll up and down lists displayed on the external display 222. In many embodiments, the external display 222 displays a single entry or only a few entries at a time, when a list could contain any number of entries or there is more data than can be displayed. The scrolling can be implemented by a user through the selection or activation of one or more buttons or other actuators, such as, one or more buttons positioned on the sides of one or both of the clam parts 122, 124. For example, buttons for volume up 150 and volume down 152 can be used to scroll through the entries in a list displayed on the external display 222 when one entry is displayed at one time on the external display, and/or other buttons can be used to scroll the data on the external display. Some embodiments are implemented such that they typically do not output audio data when the clam device is closed. As a result, the use of the volume buttons to scroll through data does not adversely affect the operation of the device. Buttons other than one or more of the volume buttons can, however, be used if desired.

Because of the dimensions of the clam device 120, the external display 222 has a limited size. This limited size limits the amount of data that can be displayed at a given time. Further, the sizes of characters displayed on the external display are limited so that the data is visible and/or readable to a user. In some embodiments, the sizes of the characters can be adjusted. Even with small characters, however, there is still a limit to the amount of data displayed at a give time. For example, if a user is accessing an address book, the address book may contain any number of individuals, companies, organizations and/or other contacts. Each entry in the address book may have additional information associated with that entry, such as mobile phone number, home phone number, work phone number, address, fax number, email address, Internet site address and substantially any other information.

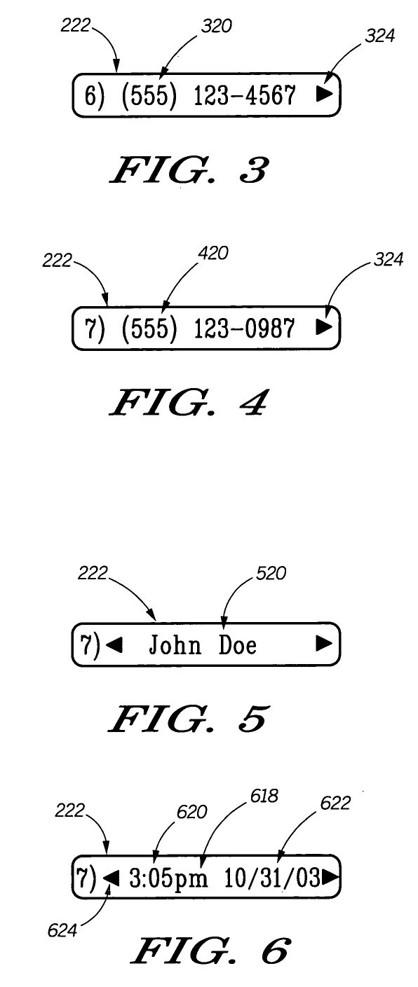

When data is displayed on the external display 222, such as the address book, or a “Recent Calls” list, the display and character sizes may be such that only a single string is shown on the display, such as a phone number (e.g., (555) 123-4567). FIGS. 3-7 show a simplified view of an external display 222 with at least a portion of one entry or line of data being displayed. Other information, however, may be stored or available that is associated with the entry being viewed, such as names, time of call, other phone numbers and/or other contact information. Further, some embodiments limit each entry to a single line on the list when displayed on the external display 222. For example, the list being viewed on the external display 222 can be the Recent Calls list, which contains a certain number of calls that were recently received and/or made. The displayed data can be substantially any data, list (such as an address book, Recent Calls list and the like) text data and other similar data and lists.

Again, because of the limited space available on an external display 222, the display typically only shows one entry 320, and often only a portion of one entry from the list at a given time. FIG. 3 depicts a simplified block diagram of an external display 222 according to some embodiments. The display 222 of FIG. 3 shows only a portion of an entry of data, such as a list of data. If a user is viewing an entry 320 from a Recent Calls list, such as a sixth most recent call (e.g., “6) (555) 123-4567”), only that entry is shown on the display 222. If the user wants to view the previous entry, such as the seventh most recent call (e.g., “7) (555) 123-0987”), the user can select or press one of the side buttons (e.g., the volume up button 150) to shift or scroll through the Recent Calls list. The display then scrolls or shifts up through the data list to display the next entry 420 (e.g., the seventh most recent call).

FIG. 4 shows the external display 222 similar to that of FIG. 3, with a subsequent entry 420 in a list (e.g., the seventh most recent call, “7) (555) 123-0987”). There may be additional information associated with the entry that the user wants to access without having to open the clam device, such as the name of the person associated with the phone number, a time and date of the phone call and other such information. In some embodiments, the external display 222 can include an indicator 324 that notify a user when additional information is available for the entry 420 being viewed. FIGS. 3 and 4 include right arrow 324 indicating that there is additional information available for the specific entry being viewed (e.g., entry 420).

Preferred embodiments allow the user to additionally scroll right and/or left along the data displayed on the external display 222. In some of these embodiments, alternative and/or additional buttons are used, typically buttons on the sides of the device 120. Many of these clam devices 120, however, have limited spacing on the sides of the two pieces 122, 124. Further, many devices have predefined layouts that have been established for manufacturing purposes. As such, to include additional buttons on the sides of the device may be costly to implement.

Some preferred embodiments allow a user to scroll left or right through additional text of a single entry by selecting a third button 254, such as a control key, some times referred to as a “Smart” key, that are typically included in devices similar to the device 120, and thus are already incorporated into the manufacturing format. This avoids reconfiguring the design of the device and avoids the need for changes in manufacturing. The scrolling right or left can be achieved by selected and holding the control key 254 or some other key. Holding down the control key (for example for a predefined period of time) causes the device to recognize the scroll command to initiate the scrolling of the text on the external display. The scrolling typically occurs in a default direction, right or left. In some embodiments, the default scrolling direction (right or left) can be defined by a user.

Additionally and/or alternatively, some embodiments allow the same buttons used to scroll up and down through the entries in a list (e.g., buttons for volume up 150 and volume down 152) to be used to additionally scroll right or left across a single entry to access the additional information associated with the entry being viewed. This is accomplished by depressing and holding a third button 254, such as a control key, the smart key or some other key, that is already incorporated in devices similar to the device 120, and thus are already incorporated into the manufacturing format.

In some embodiments, the data displayed on the external display 222 can be scrolled right and/or left by depressing and holding the additional button 254 while other buttons are pressed (such as the volume up 150 and volume down 152 buttons). This additional button 254, when activated and released by itself, typically initiates additional features and functions such as activating a “Recent Calls” list, activating the address book, terminating communication (when the device 120 is providing wireless communication) and other similar functions. When the additional control button 254, however, is pressed and maintained in an active position, the additional button 254 maintains a control signal that can initiate the default right or left scroll. Additionally, pressing and maintaining the additional control button in the active position enables the volume buttons 150, 152 (and/or other buttons) to provide the secondary function of scrolling right and/or left through data displayed on the external display, where the scrolling right or left is dependent on which of the volume up and volume down buttons are selected.

FIG. 5 shows the external display 222, similar to that of FIGS. 3-4, with the entry displayed 520 following the reception of a command to shift the data a third direction, such as left or right. The command could be initiated by a user activating and maintaining the additional or control button 254 to initiate default scrolling right or left, and/or activating and maintaining the control button while activating (or pressing) one of the volume up 150 or volume down 152 buttons to scroll across the entry to view and potentially select additional data.

For example, the user can scroll to the right, to obtain a name 520 associated with the seventh phone number 420 displayed from the Recent Calls list (e.g., John Doe). The data can further be scrolled through (if additional data is available) by continuing to hold the control button 254 or selecting the volume up or down buttons 150, 152 while continuing to maintain the control signal active by continuing to press the additional control button 254. FIG. 6 shows the display 222 of FIG. 5 after the data 420 has been scrolled to show data 618 to the right, for example, displaying a time 620 and a date 622 of when the seventh phone call 420 was received and/or made. In some embodiments, an additional indicator 624 (see FIGS. 5-6) is included to indicate that additional data is available, for example, by scrolling left. The scrolling left and/or right can be implemented by scrolling one character at a time, or by scrolling a block of data at a time. For example, the data can show a phone number. If the default scroll or scroll left or right command is received, the data can scroll off the external display 222 the entire block of the phone number and scroll on the entire block of a name (e.g., John Doe). Similarly, another scroll can cause the entire block of a name to scroll off and a time and date block can be scrolled onto the display 222. Other scrolling can be implemented, such as a word at a time, everything between spaces and other similar scrolling.

In some embodiments, portions of the data can be selectable data. Once selected, the device 120 initiates additional functions. For example, a name displayed on the external display 222 might be selectable when a user is viewing a Recent Calls list. The selection of the selectable data can initiate a function on the device 120. The selection of the name could, for example, trigger the activation of an address book stored within the device (or otherwise accessible by the device).

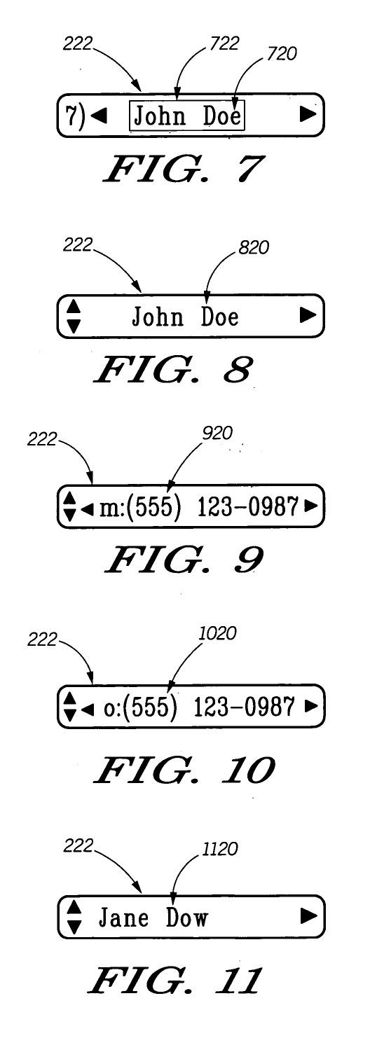

FIGS. 7-11 show a sequence of data transitions as a user selects and scrolls through data displayed on the external display 222. FIG. 7 shows data 720 similar to that of FIG. 5 where a name associated with a call from the Recent Calls list is displayed. A selection cursor 722 is shown highlighting the name, which is selectable data. In some embodiments, the selection cursor 722 simply scrolls as the user scrolls through data to highlight data that is selectable.

The selection can be accomplished in any number of different ways. In one embodiment, when scrolling left or right, the selection cursor 722 can be scrolled according to the left or right scroll commands (e.g., holding the control button 254 while selecting the volume up or down buttons). As the selection cursor reaches data defined and/or recognized as usable data, such as a name 720, phone number, an Internet site (if the handheld device 120 provides Internet access), an E-mail address (again if the handheld device 120 provides text messaging to an E-mail address) or other similar usable data, the data is highlighted by the selection cursor 722. The user can then select the highlighted, selectable data (e.g., select a name to initiate the address book, select a phone number to initiate the dialing of the phone number or other selections) through substantially any technique, such as pressing a fourth button, releasing the control button 254 and again pressing the control button, or through other similar techniques of selecting as are known in the art.

FIG. 8 shows the display 222 that displays data 820, similar to that of FIG. 7, following a selection of data, for example the selection of the name 720 associated with a recent call (see FIG. 7). This selection can activate an alternate function, such as an address book. FIG. 8 shows one entry 820 in an address book that coordinates with the data selected (e.g., data 720). The present embodiments allow the user to similarly scroll through data associated with the entry 820 that is displayed on the external display 222. The scrolling can be implemented as described above, by activating and maintaining a control signal through the control button 254 while selecting the volume up and/or down buttons 150, 152. FIG. 9 shows the external display 222 with the data scrolled, for example, right to display a mobile phone number 920 associated with the entry 820 (which could be the same as the number 420 of the Recent Calls list of FIG. 4). FIG. 10 shows additional data after further scrolling to display an additional contact number, such as an office phone number 1020. The scrolling can be continued to access all of the data associated with the entry, such as other phone numbers, fax numbers, addresses, email addresses, web site addresses and substantially any other information associated with the entry 820.

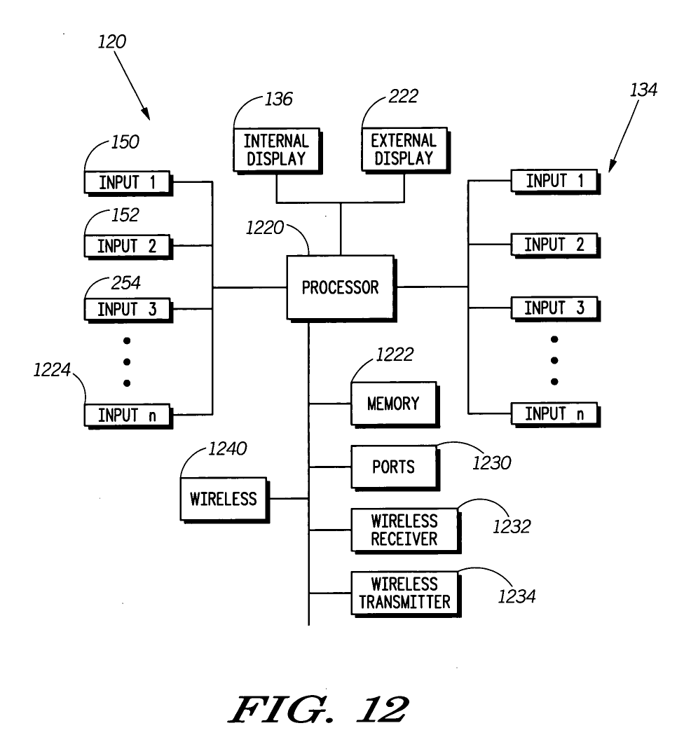

The user can additionally scroll through the entries of the list, for example, once in the address book the user can scroll through other entries of the address book. FIG. 11 shows the display of FIGS. 8-10 depicting a subsequent entry 1120 in the address book list (e.g., Jane Dow) accessed by scrolling down through the list. Again, the scrolling up and down through the list can be accomplished by pressing the volume up and/or down buttons 150, 152, while the control button is not selected and maintained as active.

FIG. 12 depicts a simplified block diagram of a handheld device 120 with operational components, according to some embodiments, including an external display 222. The device 120 includes a processor 1220. The processor can be implemented through one or more microprocessors and other similar control processors. The processor can further execute programs, scripts and other software to operate the device 120, portions of the device or applications on the device.

The handheld device 120 typically includes one or more storage devices or memory 1222. The memory can store the programs, executables, scripts, other data for the operation of the device, data stored by a user, data to be retrieved by the device, data received over communication links (wired and/or wireless) and other data and executables. For example, the memory can store Recent Calls, an address book that can include individuals, companies, associations and the like along with their contact information (i.e., phone numbers, addresses, email addresses and other contact information); data received through the handheld device 120 (e.g., text messages received, content obtained from the Internet and other data); menus of features available through the device 120 (features such as Recent Calls list, the address book), operation functions (e.g., time of day, accounting of time used of available time (i.e., free calling), clock, text messaging, Internet browser activation, voice mail, and other similar functions); games; and other similar features, functions and data.

The device 120 further includes external actuation buttons, such as the volume up 150, the volume down 152, and the control or “Smart” button 254. Some embodiments include additional external buttons 1224. Interior actuation buttons 134 are also included, for example, number buttons, scanning buttons, control buttons and other similar buttons. The processor utilizes control signals and/or commands from the external buttons (and in some embodiments the internal buttons) to, in part, control the data displayed on the external display. These commands can signal additional functions depending on the operating mode of the device 120 and/or whether the device is opened or closed (see FIGS. 1 and 2).

The processor 1220 directs data from the memory 1222 or other sources, such as from ports 1230, wireless receiver 1232 or other sources to the external display 222. The device 120 further includes an interior display 136 that displays similar data as that displayed on the external display 222 as well as other data that cannot be displayed on the external display.

In some preferred embodiments, the device 120 further includes wireless communication circuitry 1240. The wireless communication circuitry can include the signal processing circuitry to enable the transmission and reception of wireless communications. The wireless communication circuitry further coupled with the wireless receiver 1232 and wireless transmitter 1234 (and/or a transceiver) for receiving and transmitting wireless communications.

It will be apparent to one skilled in the art that other components not shown in FIG. 12 can be incorporated into the device 120. The additional components can include components that are common in wireless phones, PDAs and other handheld devices that provide operation, processing, control, communication and other similar functions.

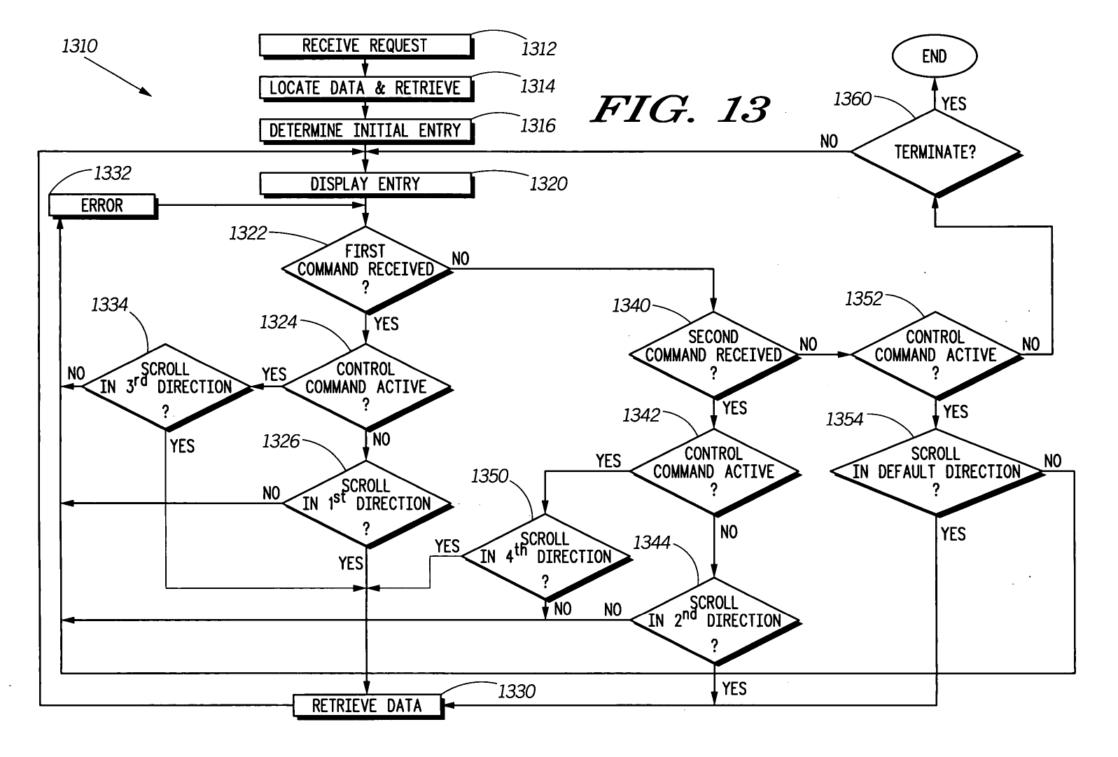

FIG. 13 depicts a simplified flow diagram of a process 1310 for displaying data on an external display 222. In step 1312, a request to display data on the external display is received. This request can be triggered by substantially any input, such as, but not limited to, a selection by the user of the control button 254 to activate a Recent Calls list, a notification of a received wireless communication, and other similar triggers to activate displaying data on the external display. In step 1314, the data requested is located and at least a portion is retrieved. For example, the data might be stored in a local memory, the data might be received through a communication (e.g., wired or wireless communication), and other similar sources of data. In step 1316, the process 1310 determines at least a portion of the requested data that is to be initially display on the external display 222. For example, if the data to be displayed is a Recent Calls list, the phone number associated with the most recent call (received and/or made) will be displayed. Similarly, if the data to be displayed is an address book, an entry identified as first in the alphabet is displayed.

In step 1320, the determined portion of data is displayed on the external display 222 (e.g., the most recent phone number of the phone trying to call the subject device 120). In step 1322, the process 1310 determines if a first command to scroll the data in a first direction, such as a command to scroll the data in an up direction (e.g., the selection of a first volume button 150) to display a succeeding entry in a list, is received. If a first command is received, the process continues to step 1324 to determine if an alternate or control command is also currently selected and/or active when the first command is received. For example, it is determined if the control or Smart button 254 is selected while a first volume button (e.g., the volume down button 152) is selected.

If it is determined in step 1324 that the control command is not currently active when the first command is received, the process continues to step 1326 to determine if the data can be scrolled in the requested first direction. For example, if the data being displayed is an entry in a Recent Calls list, step 1326 determines if there is another succeeding entry. If the data can be scrolled in the desired first direction (e.g., up direction), step 1330 is entered where the next data to be displayed is retrieved. The process then returns to step 1320 to display the data or a portion of data retrieved in step 1330. If the data cannot be scrolled in the first direction (e.g., the entry displayed is the last entry in a list and the data cannot be scrolled), the process continues to step 1332 where an error or notification is issued (e.g., the device can beep, a message can be displayed on the external display or other notifications and/or combination of notifications).

Alternatively, in some embodiments, if an end of a list is reached, the request to continue to scroll will scroll the data back around to the beginning of the list (e.g., if the data being displayed is an address book, and an entry displayed is the last entry of the book, such as a name beginning with “Z”, and a scroll down command is received, the address book can scroll back to the beginning of the address book, such as to a name beginning with “A”.) If the process allows a continuous scroll back to the beginning (and/or end) of a list, the process avoids step 1332 and transitions to step 1330 to retrieve the data associated with the beginning (or end) of the list.

If, in step 1324, the control command is active and/or simultaneously activated when the first command is received, the process proceeds to step 1334 where it is determined if the data can be scrolled or shifted in a third direction, such as shifting the data to the left. If the data can be scrolled in the third direction, the process continues to step 1330 where the data to be displayed by scrolling in the third direction is retrieved. The process returns to step 1320 to display the retrieved data. If the data cannot be scrolled in the third direction, step 1332 is entered where an error or notification is activated. The process 1310 then returns to step 1322 to determine if a command is received.

If the process 1310 determines in step 1322 that the first command is not received, the process continues to step 1340 where it is determined if a second command is received to scroll or shift the data (e.g., the selection of a second volume button 152) in a second direction, such as to display a preceding entry in a list. If the second command is received, step 1342 is entered where it is determined if the alternate or control command is also currently selected and/or active when the second command is received.

If the control command is not currently active when the second command is received, step 1344 is entered where it is determined if the data can be scrolled in the requested second direction (e.g., it is determined if the data being displayed is an entry at the beginning of a list). If the data can be scrolled in the second direction the process continues to step 1330 to retrieve the next data to be displayed. The process then returns to step 1320 to display the data or portion of retrieved data. If it is determined in step 1350 that the data cannot be scrolled, step 1332 is entered where the error or notification is issued, and the process returns to step 1322.

If it is determined in step 1342 that the control command is active and/or simultaneously activated when the second command is received, the process proceeds to step 1350 where it is determined if the data can be scrolled or shifted in a fourth direction, such as shifting the data to the right to view preceding characters of a line of an entry. If the data can be scrolled in the fourth direction, step 1330 is entered where the data to be displayed by scrolling in the fourth direction is retrieved. The process 1310 then returns to step 1320 to display the retrieved data. If the data cannot be scrolled in the fourth direction, step 1332 is entered where an error or notification is activated. The process 1310 then returns to step 1322 to determine if a command is received.

If it is determined in step 1340 that a second command is not received, the process 1310 continues to step 1352 where it is determined if the control command is active and has been active for a predefined period. If the control command has been active for the predefined period, step 1354 is entered where it is determined if the data can be scrolled in a default direction (e.g., it is determined if the data can be scrolled left). If the data can be scrolled in the default direction the process continues to step 1330 to retrieve the next data to be displayed. The process then returns to step 1320 to display the data or portion of retrieved data. If it is determined in step 1354 that the data cannot be scrolled, step 1332 is entered where the error or notification is issued, and the process returns to step 1322.

If it is determined in step 1352 that the control command is not active and has not been active for the predefined period, step 1360 is entered where it is determined if the process 1310 is to be terminated. For example, step 1360 determines if an exit command is received to exit the current list, a command to turn off external display 222 is received, a command to initiate an alternative action (e.g., a command to activate a call through the selection of an entry from a Recent Calls list), a command to display alternate data on the external display and other similar events to terminate the process 1310. If it is determined in step 1360 that the process is not terminated, the process returns to step 1320 to determine if commands have been received, otherwise, the process is terminated.

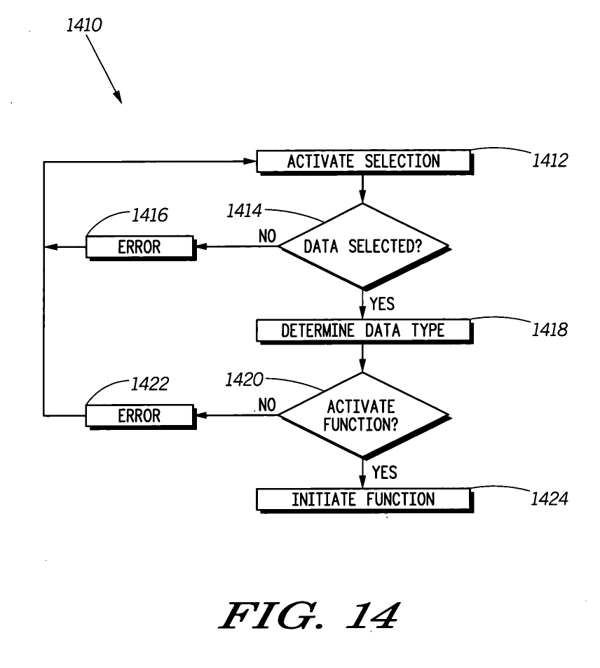

FIG. 14 shows a simplified flow diagram of a process 1410 for selecting data displayed on the external display. In step 1412, a command to activate a selection is received. For example, the alternate or control button 254 can be selected twice in rapid succession, the control button can be selected simultaneously with or while another button is active, or other similar activations. In step 1414 it is determined if data is selected. If data is selected, step 1416 is entered where an error or other notification is issued indicating data has not been selected. The process can then return to step 1412 to await activation. If data is selected, step 1418 is entered where the type of data selected is determined. For example, the process 1410 can determine if the data selected is a phone number, a web site, an email address or other data.

In step 1420 it is determined if the function associated with the selected data can be activated by the device 120. For example, if the data selected is a phone number, the process determines if a phone call can be initiated. Similarly, if the data is a web site, the process can determine if the internet can be accessed (e.g., if the device 120 is a wireless device, the process determines if the wireless device can wirelessly access the Internet). If the function cannot be implemented, for example, because the Internet cannot be accessed (either because the device does not have the capabilities, the connection cannot be established or other similar criteria), step 1422 is entered where an error or other notification is issued (e.g., a beep can be sounded, a message can be displayed and other similar notifications and/or combination of notifications can be issued). If the function associated with the selected data can be implemented, step 1424 is entered where the function is initiated according to the selected data (e.g., initiates a wireless call by dialing the selected phone number; accesses an internet site according to a selected web address; activates text messaging to receive text to be sent; and other similar functions).

While these embodiments have been described by means of specific embodiments and applications thereof, numerous modifications and variations could be made thereto by those skilled in the art without departing from the scope of the invention set forth in the claims.

1. An apparatus for use in wirelessly communicating, comprising:
a first part having an interior surface and an exterior;
a second part having an interior surface and an exterior, wherein the second part is pivotably attached with the first part such that in a closed position the interior surface of the first part is proximate to and faces the interior surface of the second part;
an exterior display mounted on the exterior of the first part to display data;
a first actuator accessible from the exterior of one of the first and second parts, wherein the first actuator when activated causes a shift of the data on the exterior display such that a first alternate portion of the data is displayed;
a second actuator accessible from the exterior of one of the first and second parts, wherein the second actuator when activated causes a shift of the data on the exterior display such that a second alternate portion of the data is displayed; and
a third actuator accessible from the exterior of one of the first and second parts, wherein the third actuator causes a shift in a default direction of the data on the exterior display such that a third alternate portion of the data is displayed when the third actuator is activated and held activated for a predefined period of time.

2. The apparatus of claim 1, wherein the first actuator causes a shift of the data on the exterior display such that a fourth alternate portion of the data is displayed when the first actuator is activated while the third actuator is activated, and wherein the second actuator causes a shift of the data on the exterior display such that a fifth alternate portion of the data is displayed when the second actuator is activated while the third actuator is activated.

3. The apparatus of claim 2, wherein the first, second and third actuators are positioned on a side of one of the first and second exteriors such that the first, second and third actuators are accessible when the first and second parts are in the closed position.

4. The apparatus of claim 3, wherein the first actuator causes the shift of the data on the exterior display to shift a first direction when the first actuator is activated while the third actuator is activated such that the third alternate portion of the data displayed is a first portion of a first entry of a list; and
the second actuator causes the shift of the data on the exterior display to shift a second direction when the second actuator is activated while the third actuator is activated such that the fourth alternate portion of the data displayed is a second portion of the first entry of the list.

5. The apparatus of claim 4, wherein the third alternate portion of the data is equal to one of the fourth and fifth alternate portions of data.

6. The apparatus of claim 4, wherein the first actuator causes the shift of the data on the exterior display to shift a third direction when the first actuator is activated while the third actuator is not activated such that the first alternate portion of the data displayed is a first portion of a succeeding second entry of the list; and
the second actuator causes the shift of the data on the exterior display to shift a fourth direction when the second actuator is activated while the third actuator is not activated such that the second alternate portion of the data displayed is a first portion of a preceding third entry of the list.

7. The apparatus of claim 6, further comprising:
a processor coupled with the first, second and third actuators, wherein the processor receives the activation of the first, second and third actuators and directs the data to the exterior display.

8. The apparatus of claim 7, further comprising:
a selection cursor that is displayed on the exterior display indicating a portion of the data that is selected; and
the processor is configured to initiate wireless communication in accordance with the selected portion of data.

9. The apparatus of claim 7, wherein the third actuator initiates the data to be displayed on the exterior display when actuated.

10. The apparatus of claim 2, further comprising:
a selection cursor that is displayed on the exterior display indicating a portion of the data that is selected, wherein the selection cursor is shifted to highlight at least a portion of the first alternate portion of the data when the first actuator is activated, the selection cursor is shifted to highlight at least a portion of the second alternate portion of the data when the second actuator is activated, the selection cursor is shifted to highlight at least a portion of the third alternate portion of the data when the first actuator is activated while the third actuator is activated, and the selection cursor is shifted to highlight at least a portion of the fourth alternate portion of the data when the second actuator is activated while the third actuator is activated.

11. A method for use in accessing data on a portable, handheld device, comprising:
displaying data on an external display of a handheld device while the handheld device is in a closed position; and
while the handheld device is closed:
receiving a first command and scrolling the data on the external display in a first direction to display first additional data;
receiving a second command and scrolling the data on the external display in a second direction to display second additional data;
receiving the first command while a third command is active and scrolling the data on the external display in a third direction to display third additional data; and
receiving the second command while the third command is active and scrolling the data on the external display in a fourth direction to display fourth additional data.

12. The method of claim 11, further comprising:
receiving the third command;
receiving the third command for a predefined period while the neither the first and second commands are active; and
scrolling the data on the external display in a default direction to display fifth additional data when the third command is active for the predefined period while the neither the first and second commands are active.

13. The method of claim 11, wherein the displaying data comprises displaying a first portion of a first entry, the scrolling in the third direction to display the third additional data comprises scrolling the data in the third direction to display a second portion of the first entry of data, and the scrolling in the fourth direction to display the fourth additional data comprises scrolling the data in the fourth direction to display a third portion of the first entry of data.

14. The method of claim 13, wherein the scrolling in the first direction to display the first additional data comprises scrolling the data in the first direction to display a first portion of a second entry, and the scrolling in the second direction to display the second additional data comprises scrolling the data in the second direction to display a first portion of a third entry of data.

15. The method of claim 14, wherein the first direction is up, the second direction is down, the third direction is right and the fourth direction is left.

16. The method of claim 11, further comprising:
shifting a selection cursor in the first direction when the first command is received, shifting the selection cursor in the second direction when the second command is received, shifting the selection cursor in the third direction when the first command is received while the third command is received, and shifting the selection cursor in the fourth direction when the second command is received while the third command is received.

17. The method of claim 11, wherein the data comprises data wirelessly received.

18. A method for use in displaying data on a handheld device, comprising:
displaying a first portion of a first entry of data on an external display of a handheld device while the handheld device is in a closed position;
displaying a first portion of a second entry of data on the external display when a first command is received while a third command is not received;
displaying a second portion of the first entry of data on the external display when the first command is received while the third command is received; and
displaying a third portion of the first entry of data on the external display when a second command is received while the third command is received.

19. The method of claim 18, further comprising:
displaying a first portion of a third entry of data on the external display when the second command is received while the third command is not received.

20. The method of claim 18, further comprising:
displaying a second portion of the second entry of data on the external display when the first command is received while the third command is received and while the second entry is displayed on the external display; and
displaying a third portion of the second entry of data on the external display when the second command is received while the third command is received and while the third entry is displayed on the external display.

21. The method of claim 20, further comprising:
determining if a fourth portion of the first entry is selected when a fourth command is received;
accessing an alternate data list when the fourth portion is selected; and
displaying a first portion of a first entry of the alternate data list.
